(19) United States
(12) Patent Application Publication
(10) Pub. No.: US 2011/0285671 A1
(43) Pub. Date: Nov. 24, 2011

(54) STYLUS AND ELECTRONIC DEVICE

(76) Inventors: Chia-Hsien Wu, TAIPEI CITY (TW); Chia-Wei Chang, TAIPEI CITY (TW); Wen-Chung Cheng, TAIPEI CITY (TW)

(21) Appl. No.: 13/082,411

(22) Filed: Apr. 8, 2011

(30) Foreign Application Priority Data
May 24, 2010 (TW) 099116503

(51) Int. Cl. G06F 3/033; G09G 5/00

(52) U.S. Cl. 345/179; 345/156

(57) ABSTRACT

This invention provides a stylus and an electronic device. The electronic device includes a stylus and a main body. The main body includes a display screen and at least one sensing element. The stylus is detachably connected with the main body. The stylus includes a penholder and a movable element. The movable element is disposed at the penholder and allowed to pivot around or slide along the penholder which is used as an axis. The sensing element senses the pivoting or sliding of the movable element to generate a control signal. The main body controls a display frame of the display screen according to the control signal.

### CROSS-REFERENCE TO RELATED APPLICATIONS

This Non-provisional application claims priority under 35 U.S.C. §119(a) on Patent Application No(s). 099116503 filed in Taiwan, Republic of China on May 24, 2010, the entire contents of which are hereby incorporated by reference.

### BACKGROUND OF THE INVENTION

1. Field of the Invention

This invention relates to an electronic device and, more particularly, to an electronic device with a stylus.

2. Description of the Related Art

FIG. 1 is a schematic diagram showing a conventional electronic device. In FIG. 1, an electronic device 100 includes a main unit 110 and a stylus 120. The main unit 110 includes a direction key 112 and a touch display screen 114. The stylus 120 is used for touching the touch display screen 114 of the main unit 110 for selection or operation. In addition, the direction key 112 can be used for browsing a page presented on the touch display screen 114 or be used for operating a figure of a frame presented on the touch display screen 114 to move upward, downward, leftward, or rightward.

According to FIG. 1, the electronic device 100 usually includes the direction key 112 to operate information presented on the touch display screen 114. Thus, convenience and flexibility of operation by users can be improved. However, an area of the touch display screen 114 may be limited correspondingly. In addition, since keys such as the direction key 112 are needed, the number of components and the whole manufacturing cost may increase.

### BRIEF SUMMARY OF THE INVENTION

This invention provides a stylus allowing an electronic device to perform a corresponding action via rotation or sliding.

This invention further provides an electronic device with the stylus.

This invention provides an electronic device including a stylus and a main body. The main body includes a display screen and at least one sensing element. The stylus is detachably connected with the main body. The stylus includes a penholder and a movable element. The movable element is disposed at the penholder and allowed to pivot around or slide along the penholder which is used as an axis. The sensing element senses the pivoting or sliding of the movable element to generate a control signal. The main body controls a display frame of the display screen according to the control signal.

This invention further provides a stylus for being detachably connected with a main body and controlling a display frame provided by the main body. The main body includes a display screen and a sensing element. The stylus includes a penholder and a movable element. The movable element is disposed at the penholder and allowed to pivot around or slide along the penholder which is used as an axis. The sensing element senses the pivoting or sliding of the movable element to generate a control signal, and the main body controls the display frame of the display screen according to the control signal.

In one embodiment of the invention, the main body may further include a containing groove, and the penholder of the stylus may be detachably contained in the containing groove.

In one embodiment of the invention, the movable element may be fastened to the penholder, and when the movable element pivots around or slides along the axis, the penholder may be linked to roll or slide in the containing groove.

In one embodiment of the invention, the sensing element may include two triggered elements, and the triggered elements may correspond to two ends of the penholder, respectively, and may be adjacent to the containing groove. When the penholder slides in the containing groove, the penholder may trigger one of the triggered elements to allow the corresponding triggered element to generate the control signal.

In one embodiment of the invention, the movable element may be pivotally disposed at the penholder to allow the movable element to pivot around or slide along the axis relative to the penholder.

In one embodiment of the invention, the sensing element may include a gear. When the stylus is connected with the main body, the movable element contacts the gear thus to drive the gear to generate the control signal when the movable element pivots around or slides along the axis.

In one embodiment of the invention, the sensing element may include a wireless receiving unit, and the stylus may further include a signal generating unit and a wireless transmitting unit. The signal generating unit is used for outputting a moving signal to the wireless transmitting unit according to the pivoting or sliding of the movable element along the axis. The wireless transmitting unit is used for transmitting the moving signal to the wireless receiving unit to allow the control signal to be generated.

In one embodiment of the invention, the main body may control the display frame of the display screen to move, roll, turn over a page, or return according to the control signal.

According to the above, the electronic device in the invention includes a stylus with a movable element. A user can allow the electronic device to generate a corresponding action by rotating or sliding the movable element, such as turning over a page of the display frame presented by the electronic device or controlling the page to move, roll, or return. In addition, since the electronic device can achieve the operation such as moving upward, downward, leftward, or rightward or returning via the stylus, the number of the components (such as the direction key) and the molding cost can be reduced, and the area of the whole display frame can be increased.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a conventional electronic device;

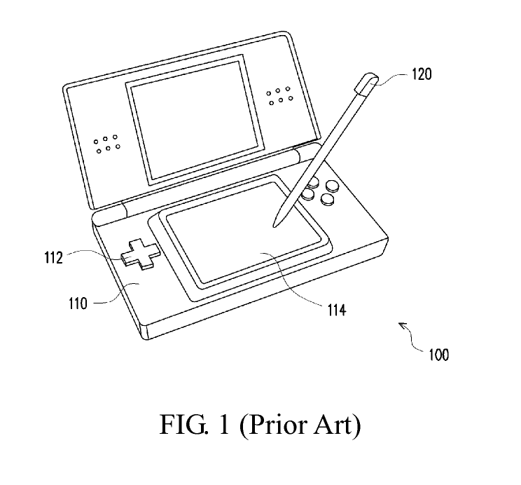

FIG. 2 is a schematic diagram showing an electronic device according to one embodiment of the invention;

FIG. 3 is a partial perspective diagram showing operation of a stylus of the electronic device when the stylus is installed in a main body in FIG. 2; and

FIG. 4 is a partial perspective diagram showing operation of a stylus of the electronic device in another form when the stylus is installed in a main body in FIG. 2.

### DETAILED DESCRIPTION OF THE INVENTION

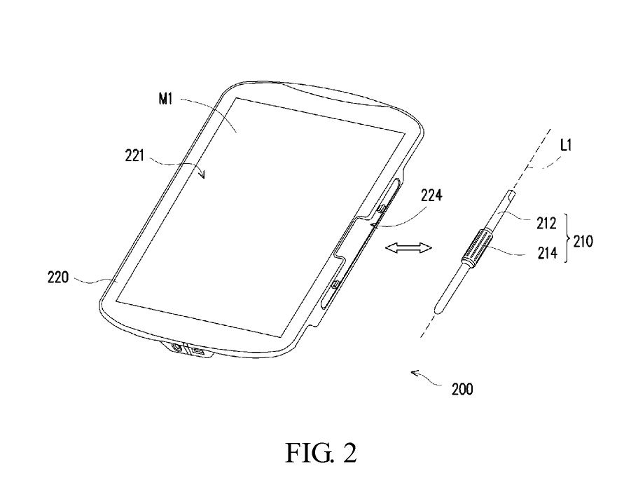

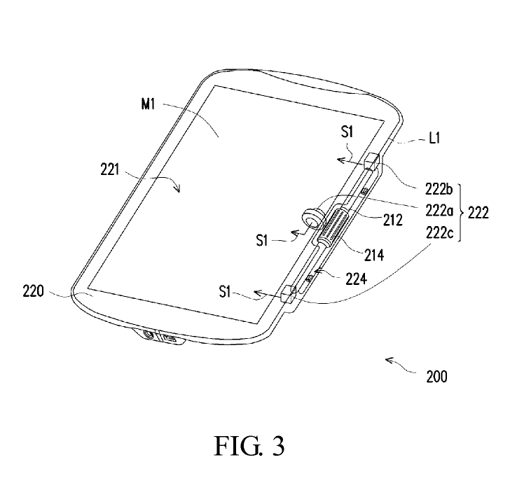

FIG. 2 is a schematic diagram showing an electronic device according to one embodiment of the invention. FIG. 3 is a partial perspective diagram showing operation of a stylus when the stylus is installed in a main body in the electronic device in FIG. 2. In FIG. 2 and FIG. 3, an electronic device 200 in the embodiment includes a stylus 210 and a main body 220. The stylus 210 is detachably connected with the main body 220 and includes a penholder 212 and a movable element 214. The movable element 214 is disposed at the penholder 212 and allowed to pivot around or slide along the penholder 212 which is used as an axis L1. In the embodiment, the movable element 214 may be fastened to the penholder 212. Thus, when the movable element 214 pivots around the axis L1 or slides along the axis L1, the movable element 214 can drive the penholder 212 to pivot or slide together. In other words, according to design and needs of users, the movable element 214 and the penholder 212 may be integrally formed. The invention is not limited thereto.

The main body 220 includes a display screen M1 and at least one sensing element 222. In FIG. 2 and FIG. 3, the display screen M1 is used for providing a display frame 221. In the embodiment, the main body 220 can further include a containing groove 224. The penholder 212 of the stylus 210 is detachably contained in the containing groove 224 thus to be connected with the main body 220, and the sensing element 222 of the main body 220 is used for sensing the pivoting or sliding of the movable element 214 to generate a control signal S1. The main body 220 controls display of the display frame 221 according to the control signal S1. In the embodiment, the sensing element 222 in FIG. 3 may be a gear 222a. The gear 222a is disposed in the containing groove 224. When the stylus 210 is disposed in the containing groove 224 and contacts the main body 220, the movable element 214 can contact the gear 222a. Therefore, when the movable element 214 pivots around the axis L1 in the containing groove 224 to drive the stylus 210 to rotate, the movable element 214 can drive the gear 222a at the same time thus to allow the control signal S1 to be generated. The main body 220 can control the display of the display frame 221 according to the control signal S1.

In detail, when a user assembles the stylus 210 in the containing groove 224 of the main body 220, the user can rotate the movable element 214 to allow the stylus 210 to pivot around the axis L1 and to drive the stylus 210 to rotate together. The movable element 214 can contact the gear 222a in the main body 220, and the movable element 214 can also drive the gear 222a when rotated. In addition, the relative movement of the gear 222a allows the control signal S1 to be generated, and the main body 220 can control the display of the display frame 221 according to the control signal S1.

For example, when the movable element 214 counterclockwise pivots toward a direction approaching the main body 220 (such as a left side as shown in FIG. 2 and FIG. 3), a function corresponding to operation of the main body 220 for the display frame 221 may turn over a page leftward. On the other side, when the movable element 214 clockwise pivots toward a direction leaving away from the main body 220 (such as a right side as shown in FIG. 2 and FIG. 3), a function corresponding to operation of the main body 220 for the display frame 221 may turn over a page rightward. However, the invention is not limited thereto. In one embodiment, the function corresponding to the operation for the display frame may be the opposite design. For example, when the movable element 214 pivots counterclockwise, the display frame 221 may turn over a page rightward. When the movable element 214 pivots clockwise, the display frame 221 may turn over a page leftward.

In addition, the sensing element 222 can further include two triggered elements 222b, 222c. The triggered elements 222b, 222c correspond to two ends of the penholder 212, respectively, and are adjacent to the containing groove 224. That is, the triggered elements 222b, 222c may be located at two opposite ends of the containing groove 224, as shown in FIG. 3. In detail, the stylus 210 is disposed in the containing groove 224, and the movable element 214 can drive the stylus 210 to slide when sliding along the axis L1. After the penholder 212 of the stylus 210 contacts one of the triggered elements 222b, 222c, the control signal S1 can be outputted. Therefore, the main body 220 can control the display of the display frame 221 according to the control signal S1.

In detail, when the user assembles the stylus 210 in the containing groove 224 of the main body 220, the user can slide the movable element 214 along the axis L1 to drive the stylus 210 to slide together. Since the stylus 210 is driven to slide when the movable element 214 slides, the stylus 210 can contact one of the triggered elements 222b, 222c when sliding, thus to allow the contacted triggered element 222b, 222c to output the control signal S1. In other words, in the embodiment, according to the control signal S1 outputted by one of the triggered elements 222b, 222c, the relative movement of the stylus 210 in the sliding direction can be determined, and the main body 220 can control the display of the display frame 221 according to the control signal S1 generated by one of the triggered elements 222b, 222c.

For example, when the movable element 214 slides upward to drive the stylus 210 to contact the triggered element 222b, the function corresponding to the operation of the main body 220 for the display frame 221 may turn over a page upward or move the page upward. On the other hand, when the movable element 214 slides downward to drive the stylus 210 to contact the triggered element 222c, the function corresponding to the operation of the main body 220 for the display frame 221 may turn over a page downward or move the page downward. The invention is not limited thereto. In one embodiment, the function corresponding to the operation for the display frame 221 may be the opposite design. For example, when the movable element 214 slides upward, the display frame 221 may turn over a page downward or move the page downward; when the movable element 214 slides downward, the display frame 221 may turn over a page upward or move the page upward.

According to the above, the electronic device 200 in the embodiment can correspondingly control the display frame 221 presented by the electronic device 200 by rotating or sliding the stylus 210. Thus, upper, lower, left, and right keys can be reduced. That is, the electronic device 200 in the embodiment can effectively reduce the number of components in use and the molding cost, and the electronic device 200 can also increase the using area of the whole display frame of the electronic device 200. In other words, the main body 220 may not include the direction key, and the main body 220 can control the display frame 221 of the display screen M1 to move, roll, turn over a page, or return according to the control signal S1.

In the embodiment, the stylus 210 rotates or slides to correspondingly perform the page turning function for the frame. However, the invention is not limited thereto. In other embodiments, the stylus 210 may rotate or slide to achieve functions of the conventional the upper, lower, left, and right keys thus to replace the conventional the upper, lower, left, and right keys. That is, the stylus 210 may rotate or slide to control the direction of the display frame 221.

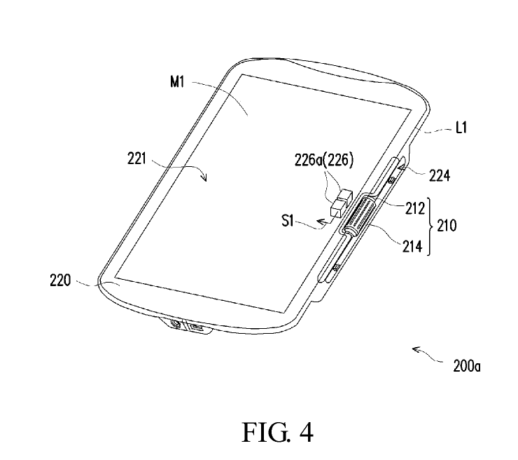

FIG. 4 is a partial perspective diagram showing operation of a stylus of an electronic device in another form when the stylus is installed in a main body in FIG. 2. In FIG. 2 and FIG. 4, an electronic device 200a in the embodiment is similar to the electronic device 200, and the difference is that a sensing element 226 of the electronic device 200a may be an electromagnetic induction element 226a, and a movable element 214 may be a magnetic element. Thus, the electromagnetic induction element 226a can sense the movement of the magnetic element 214 to generate a control signal S1. In the same way, a main body 220 can control the operation of a display frame 221 according to the control signal S1. In other words, in the embodiment, the electronic device 200a can also sense the relative movement of the stylus in the containing space in an electromagnetic induction mode, further to correspondingly control the display frame 221 provided by the main body 220, such as turning over a page or controlling directions of a page. Further, the two embodiments can be combined. That is, the electromagnetic induction and the mechanisms, such as the gear and the triggered element, can be used together to achieve the object.

In addition, the electronic devices 200, 200a in FIG. 2 to FIG. 4 only show mechanisms when the stylus 210 is disposed in the containing groove 224 to control the main body 220. In other embodiments, if the user is to input data or to perform interface operation of other functions, he or she can remove the stylus 210 from the containing groove 224 thus to purely use the stylus 210 to input data or perform other operation for the main body 220. This operation can be adjusted according to needs of the users.

In one embodiment, the sensing elements 222, 226 may be a wireless receiving unit (not shown), and the stylus 210 may include a signal generating unit (not shown) and a wireless transmitting unit (not shown) at the same time. The signal generating unit can output a moving signal (not shown) to the wireless transmitting unit of the main body 220 according to the pivoting of the movable element 214 around the axis L1 and the sliding along the axis L1, and the wireless transmitting unit can transmit the moving signal to the wireless receiving unit to allow the control signal S1 to be generated. The main body 220 can control the display of the display frame 221 according to the control signal S1.

In detail, in the embodiment, the stylus 210 may not be disposed in the containing groove 224. The user may can carry the stylus 210 in hand, and when the user uses the stylus 210 to input data, after he or she rotates or slides the movable element 214 disposed at the penholder 212, a signal corresponding to the action can be wirelessly transmitted to the main body 220, further to achieve the page turning function or the control of moving direction of the page. In other words, controlling the display frame of the main body 220 by the stylus 210 can be achieved in the wireless transmission mode instead of the physical connection.

The movable element 214 fastened to the penholder 212 is just an example. However, the invention is not limited thereto. In other embodiments, the movable element 214 may also be pivotally disposed at the penholder 212. When the movable element 214 pivots around the axis L1 or slides along the axis L1, the penholder 212 is fixed.

To sum up, the stylus and the electronic device in the embodiments of the invention at least include the following advantages. First, since the stylus includes a movable element, the user can allow the electronic device to generate a corresponding action by rotating or sliding the movable element, such as turning over a presented page or controlling a page to move. In addition, when the movable element rotates or slides, the sensing mechanism that the electronic device senses the relative movement of the movable element may be the mechanical sensing mode (such as operating modes of the gear or the triggered element in the embodiment) or the electromagnetic induction mode (such as the electromagnetic induction mode in the embodiment).

In addition, since the electronic device can achieve the upward, downward, leftward, and rightward operation via the stylus, the number of the using components (such as the direction key) and the molding cost can be reduced, and the area of the whole display frame can be increased. In addition, in the invention, the stylus can wirelessly transmit the signal of the relative movement of the movable element to the main body of the electronic device, such that the user can enjoy the above effects when operating the stylus.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An electronic device comprising:
a main body including a display screen and at least one sensing element; and
a stylus detachably connected with the main body, the stylus including:
a penholder; and
a movable element disposed at the penholder and allowed to pivot around or slide along the penholder which is used as an axis,
wherein the sensing element senses the pivoting or sliding of the movable element to generate a control signal, and the main body controls a display frame of the display screen according to the control signal.

2. The electronic device according to claim 1, wherein the main body further comprises a containing groove, and the penholder of the stylus is detachably contained in the containing groove.

3. The electronic device according to claim 2, wherein the movable element is fastened to the penholder, and when the movable element pivots around or slides along the axis, the penholder is linked to roll or slide in the containing groove.

4. The electronic device according to claim 3, wherein the sensing element comprises two triggered elements, the triggered elements correspond to two ends of the penholder, respectively, and are adjacent to the containing groove, and the penholder triggers one of the triggered elements to allow the corresponding triggered element to generate the control signal when the penholder slides in the containing groove.

5. The electronic device according to claim 1, wherein the movable element is pivotally disposed at the penholder to allow the movable element to pivot around or slide along the axis relative to the penholder.

6. The electronic device according to claim 1, wherein the sensing element comprises a gear, and when the stylus is connected with the main body, the movable element contacts the gear thus to drive the gear to generate the control signal when the movable element pivots around or slides along the axis.

7. The electronic device according to claim 1, wherein the sensing element comprises a wireless receiving unit, the stylus further comprises a signal generating unit and a wireless transmitting unit, the signal generating unit outputs a moving signal to the wireless transmitting unit according to the pivoting or sliding of the movable element along the axis, and the wireless transmitting unit transmits the moving signal to the wireless receiving unit to allow the control signal to be generated.

8. The electronic device according to claim 1, wherein the main body controls the display frame of the display screen to move, roll, turn over a page, or return according to the control signal.

9. A stylus for being detachably connected with a main body and controlling a display frame provided by the main body, the main body including a display screen and at least one sensing element, the stylus comprising:
a penholder; and
a movable element disposed at the penholder and allowed to pivot around or slide along the penholder which is used as an axis,
wherein the sensing element senses the pivoting or sliding of the movable element to generate a control signal, and the main body controls the display frame of the display screen according to the control signal.

10. The stylus according to claim 9, wherein the penholder of the stylus is detachably contained in a containing groove of the main body.

11. The stylus according to claim 10, wherein the movable element is fastened to the penholder, and when the movable element pivots around or slides along the axis, the penholder is linked to roll or slide in the containing groove.

12. The stylus according to claim 11, wherein the sensing element comprises two triggered elements, the triggered elements correspond to two ends of the penholder, respectively, and are adjacent to the containing groove, and the penholder triggers one of the triggered elements to allow the corresponding triggered element to generate the control signal when the penholder slides in the containing groove.

13. The stylus according to claim 9, wherein the movable element is pivotally disposed at the penholder to allow the movable element to pivot around or slide along the axis relative to the penholder.

14. The stylus according to claim 9, wherein the sensing element comprises a gear, and when the stylus is connected with the main body, the movable element contacts the gear thus to drive the gear to generate the control signal when the movable element pivots around or slides along the axis.

15. The stylus according to claim 9, wherein the sensing element comprises a wireless receiving unit, the stylus further comprises a signal generating unit and a wireless transmitting unit, the signal generating unit outputs a moving signal to the wireless transmitting unit according to the pivoting or sliding of the movable element along the axis, and the wireless transmitting unit transmits the moving signal to the wireless receiving unit to allow the control signal to be generated.

16. The stylus according to claim 9, wherein the main body controls the display frame of the display screen to move, roll, turn over a page, or return according to the control signal.
